(19) United States
(12) Patent Application Publication
(10) Pub. No.: US 2009/0039545 A1
(43) Pub. Date: Feb. 12, 2009

(54) SEALING STRUCTURE OF TERMINAL AND SEALING MATERIAL THEREFOR

(75) Inventors: Tetsuo Hayase, Ritto-shi (JP); Ichizo Sakamoto, Moriyama-shi (JP); Takeshi Nishida, Muko-shi (JP); Yuji Watanabe, Ritto-shi (JP); Toru Yoshikawa, Shiga-gun (JP)

Correspondence Address: OSHA LIANG L.L.P., TWO HOUSTON CENTER, 909 FANNIN, SUITE 3500, HOUSTON, TX, 77010, US

(73) Assignee: OMRON CORPORATION, Kyoto-shi (JP)

(21) Appl. No.: 12/248,718

(22) Filed: Oct. 9, 2008

Related U.S. Application Data
(62) Division of application No. 10/862,062, filed on Jun. 4, 2004.

(30) Foreign Application Priority Data
Jun. 5, 2003 (JP) 2003-160917
Apr. 19, 2004 (JP) 2004-123062

(51) Int. Cl. B29C 65/40

(52) U.S. Cl. 264/236; 264/261

(57) ABSTRACT

The present invention intends to provide a sealing structure of a terminal that is low in a processing temperature for sealing, easy in sealing operation and high in the productivity. In the invention, the thermal expansion coefficient of a sealing material is made equivalent to or more than the linear expansion coefficient of a metallic sealing case block by adding inorganic filler to a liquid thermosetting polymer.

### BACKGROUND OF THE INVENTION

1. Field of the Invention

The present invention relates to a sealing structure of terminal, for instance, a sealing structure of terminal used for switchgears such as electromagnetic relays, switches and timers that open and close a circuit.

2. Description of the Related Art

As an existing sealing structure of terminal involving switchgear made of a metallic housing, there is, for instance, a thermally actuated switch (patent literature 1).

That is, a metallic container 2 and a lid plate 3 constitute a sealed container, and in two throughholes in the lid plate 3, respectively, conductive terminal pins 8A and 8B are insulated and fixed with electrically insulating filler 7. Inside of the container 2, a thermally actuatable plate is fixed, and a traveling contact 6 and a fixed contact 9 form a contact mechanism. A heater 10 is connected and fixed to the conductive terminal pin 8B and the lid plate 3, and at fusing of the contact, the contact is partially molten down to break an electric circuit. A surface on an internal side of the sealed container of the electrically insulating filler 7 is covered with a heat-resistant inorganic insulating material 11.

[Patent literature 1] JP-A No. 10-144189 (FIG. 3)

However, in the thermally actuatable switch, in order to air-tightly and insulatively fix the conductive terminal pins 8A and 8B according to hermetic sealing, glass is used as electrically insulating filler 7. Accordingly, since a processing temperature of the electrically insulating filler 7 is high, there are problems in that sealing operation not only takes many man-hours but also is low in the productivity.

The present invention, in view of the above situations, intends to provide a sealing structure of terminal that is low in a temperature for processing, easy to seal and high in the productivity.

### SUMMARY OF THE INVENTION

As a sealing structure of terminal according to the present invention, in order to overcome the above problems, in a sealing structure in which a terminal is inserted in a terminal hole disposed to a metallic housing and at the same time a sealing material is injected therein and solidified to seal, the thermal expansion coefficient of the sealing material, by adding an inorganic filler to a liquid thermosetting polymer, is made equal to or more than a linear expansion coefficient of the metallic housing.

As another sealing structure of terminal according to the invention, in a sealing structure where a terminal is inserted in a terminal hole of a resinous housing exposed from an opening of a metallic housing and at the same time a sealing material is injected in the opening of the metallic housing and solidified to seal, the thermal expansion coefficient of the sealing material, by adding an inorganic filler to a liquid thermosetting polymer, may be made equal to or more than a linear expansion coefficient of the metallic housing.

According to the invention, since the thermal expansion coefficient of the sealing material is equal to or more than the linear expansion coefficient of the metallic housing, even when the heat shock is inflicted thereon owing to expansion or contraction due to heating or cooling, since there is not caused a large stress between the terminal and the metallic housing, desired sealability can be secured. In particular, since the sealing material according to the invention is mainly made of a liquid thermosetting polymer, different from glass according to an existing example, a sealing structure that is low in a processing temperature, easy in sealing operation and high in the productivity can be obtained.

As an embodiment according to the invention, the liquid thermosetting polymer may be a latent epoxy resin. Furthermore, the inorganic filler may be aluminum oxide powder having an average particle diameter of 1 to 30 μm. Still furthermore, an addition amount of the inorganic filler has only to be 70 to 85% by weight.

According to the present embodiment, since a main component of the sealing material is a liquid thermosetting polymer, not only the sealing operation is easy but also, by appropriately selecting a particle diameter, a kind and an amount of the inorganic filler, various kinds of sealing material can be obtained; accordingly, a sealing structure of terminal in which a convenient sealing material can be used to seal can be obtained.

As another invention, in a sealing material that is injected in a terminal hole of a metallic housing where the terminal has been inserted and solidified to seal, an inorganic filler may be added to a liquid thermosetting polymer to make the thermal expansion coefficient of the sealing material equal to or more than the thermal expansion coefficient of the metallic housing.

As still another invention, in a sealing material that is injected in an opening of a metallic housing where a terminal hole of a resinous housing and a terminal inserted in the terminal hole are exposed and solidified to seal, an inorganic filler may be added to a liquid thermosetting polymer to make the thermal expansion coefficient of the sealing material equal to or more than the thermal expansion coefficient of the metallic housing.

According to the inventions, since the thermal expansion coefficient of the sealing material is equal to or more than that of the metallic housing, even when the heat shock is inflicted thereon owing to expansion or contraction due to heating or cooling, since there is not caused a large stress between the terminal and the metallic housing, desired sealability can be secured. In particular, since the sealing material according to the invention is mainly made of a liquid thermosetting polymer, different from glass according to an existing example, a sealing material that is low in a processing temperature, easy in sealing operation and high in the productivity can be obtained.

Furthermore, since a main component of the sealing material is a liquid thermosetting polymer, not only the sealing operation is easy but also, by appropriately selecting a particle diameter, a kind and an amount of the inorganic filler, various kinds of sealing material can be obtained; accordingly, a sealing structure in which a convenient sealing material can be used as a sealing material can be obtained.

### BRIEF DESCRIPTION OF THE DRAWINGS

FIG. 1 is a front sectional view of gearswitch showing a first embodiment of a sealing structure according to the present invention.

FIG. 2 is a side sectional view of the gearswitch shown in FIG. 1.

FIG. 3 is an exploded perspective view of the gearswitch shown in FIG. 1.

FIG. 4 is an exploded perspective view of a relay body shown in FIG. 3.

FIG. 5 is an exploded perspective view of an electromagnet block shown in FIG. 4.

FIG. 6 is an exploded perspective view of a seal case block shown in FIG. 5.

FIGS. 7A and 7B are tables showing the viscosity characteristics of a sealing material according to the present embodiment.

FIG. 8 is a front sectional view of gearswitch showing a second embodiment of a sealing structure according to the invention.

FIG. 9 is a side sectional view of the gearswitch shown in FIG. 8.

FIG. 10 is an exploded perspective view of the gearswitch shown in FIG. 8.

FIG. 11A is a sectional view showing Embodiment 1, FIG. 11B being a sectional view showing Embodiment 2.

FIG. 12 is a schematic diagram showing a measurement method of Embodiments 1 and 2.

FIG. 13 is a schematic diagram showing a measurement method of Embodiments 3 and 4.

FIGS. 14A through 14D are diagrams, respectively, showing measurements and calculation results of Embodiments 1, 2, 3 and 4.

### DESCRIPTION OF THE PREFERRED EMBODIMENTS

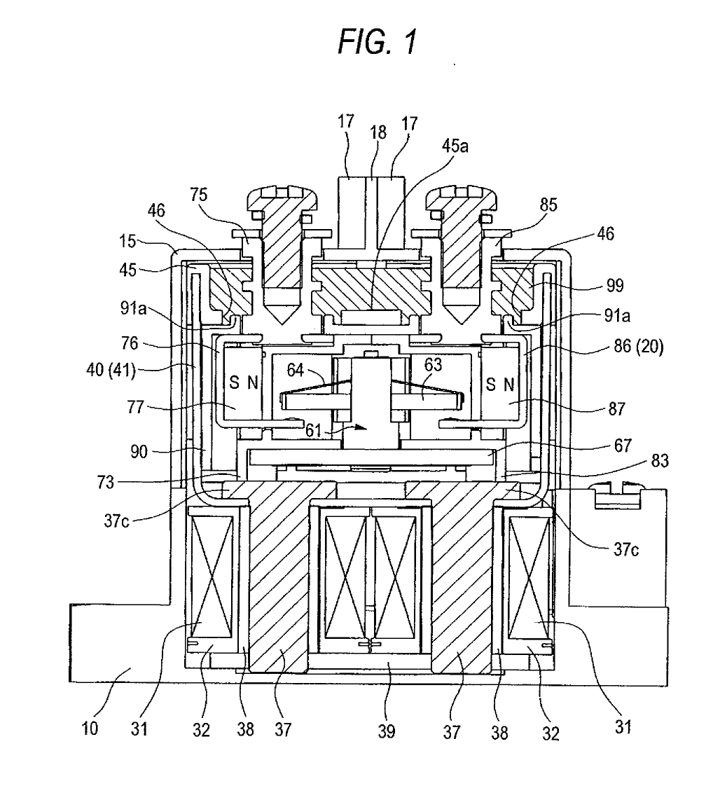

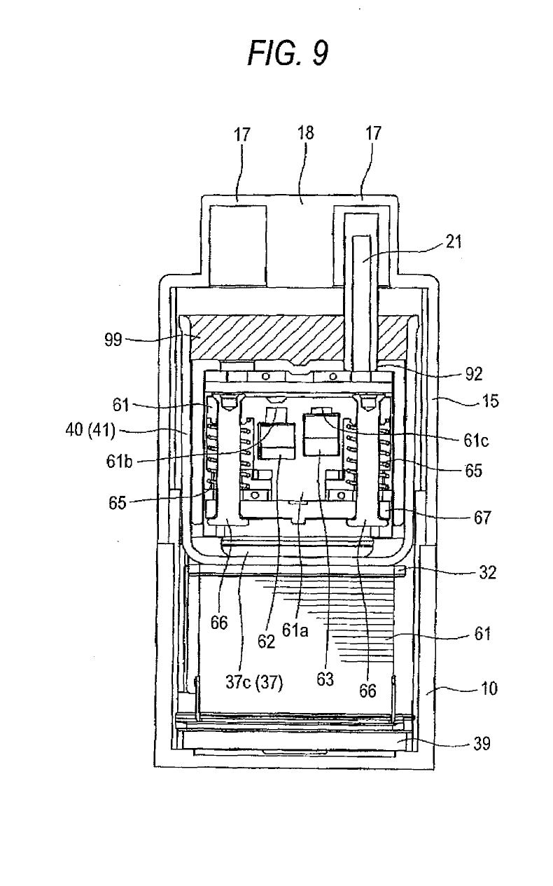

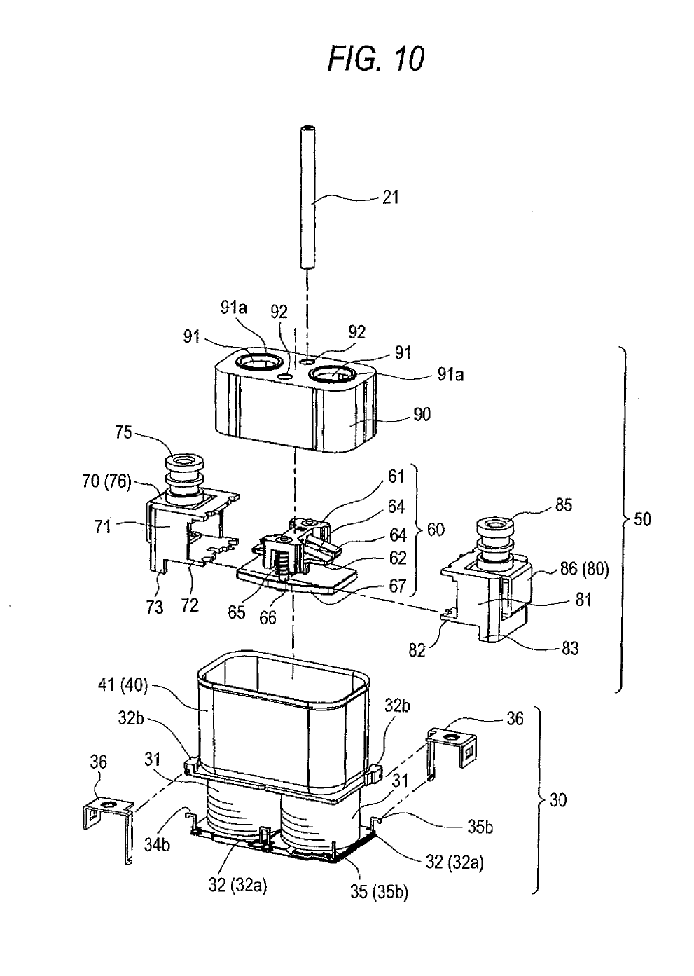

Embodiments according to the present invention will be explained with reference to FIGS. 1 through 10.

A first embodiment according to the invention, as shown in FIGS. 1 through 7, relates to a case where the invention is applied to an air-tightly sealed DC switching relay, wherein in a space partitioned by an integrated box type case 10 and a box type cover 15, a relay body 20 is housed.

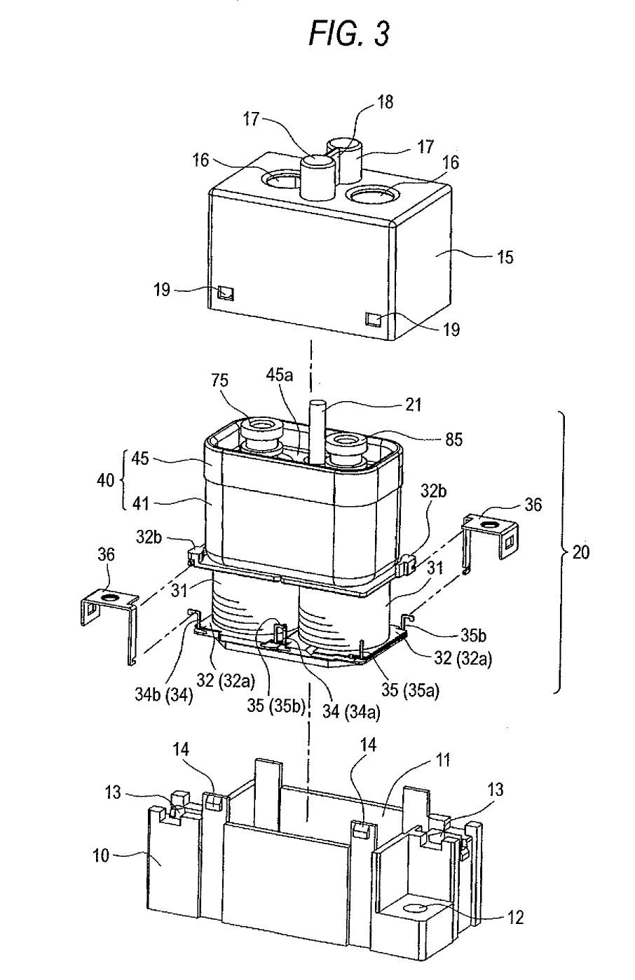

As shown in FIG. 3, the box type case 10 has a recess 11 capable of housing an electromagnet block 30 described later, is provided with a pair of fixing throughholes 12 at planate corner portions located on a diagonal line and connecting recesses 13 at remaining planate corner portions. In each of the connecting recesses 13, a connecting clasp (not shown in the drawing) is embedded.

The box type cover 15 is capable of engaging with the box type case 10 and has a shape capable of housing a seal case block 40 described later. Furthermore, on a surface of a ceiling of the box type cover 15, connection holes 16 and 16 through which connecting terminals 75 and 85 of the relay body 20 project are provided and projections 17 and 17 for housing gas venting pipes 21 are projected. The projections 17 and 17 are connected with a partition wall 18 and these have a function also as an insulating wall. When engaging holes 19 disposed at lower opening rim portions of the box type cover 15 and engaging nails 14 disposed at upper opening rim portions of the box type case 10 are engaged, both are bonded into one body.

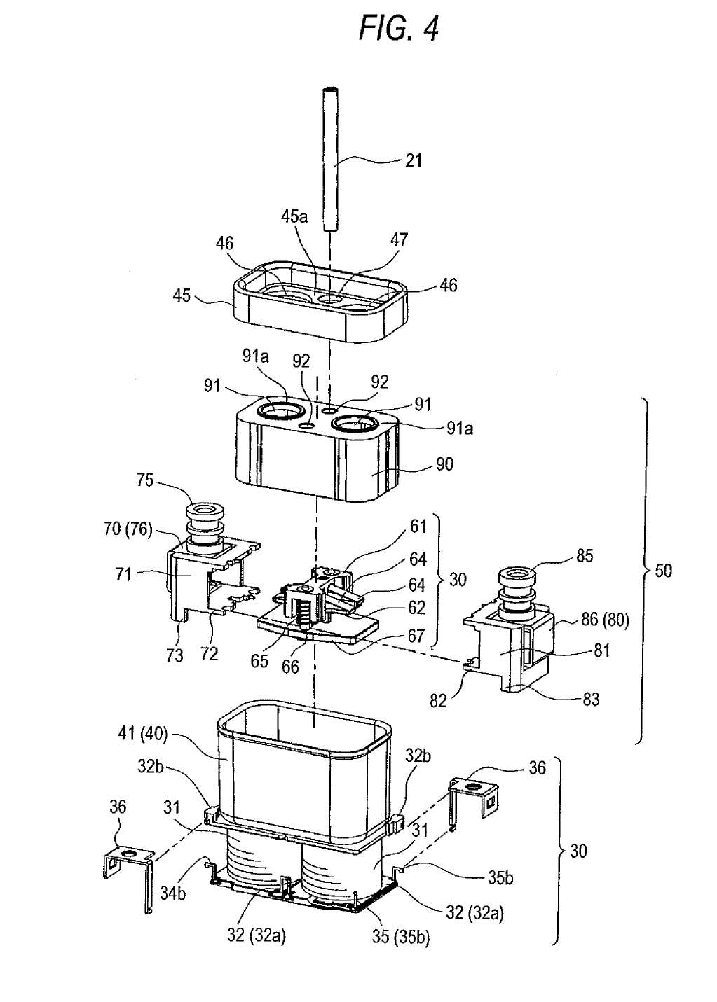

As shown in FIG. 3, the relay body 20 is one where a contact mechanism block 50 (FIG. 4) is hermetically sealed in a seal case block 40 mounted on the electromagnet block 30.

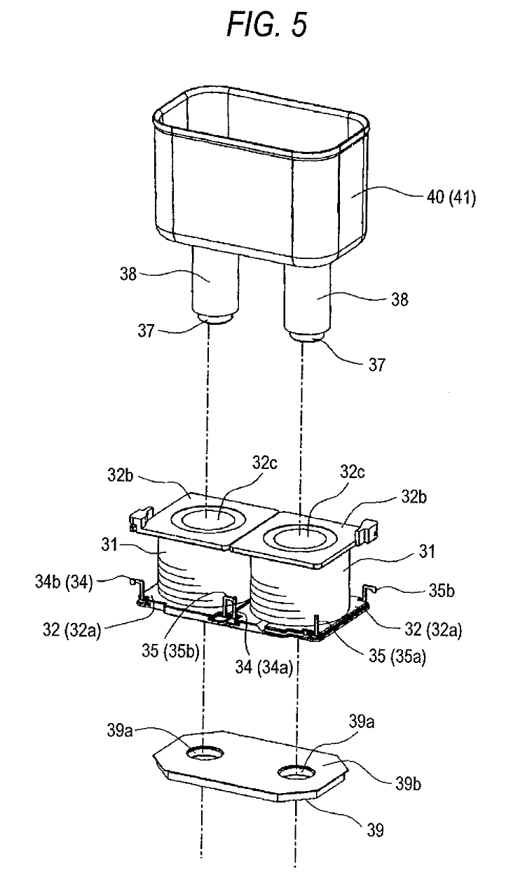

As shown in FIG. 5, the electromagnet block 30 is one where a pair of spools 32 around each of which a coil 31 is wound are disposed side by side and integrated through two iron cores 37 and 37 and a yoke 39 into one body.

In the spool 32, of sword guard portions 32a and 32b disposed at both ends thereof, on opposing end surfaces on both sides of a lower sword guard portion 32a, relay terminals 34 and 35 each are laterally press-fitted. The coil 31 wound around the spool 32 is tied up and soldered at one end portion of the coil to one end portion (tying up portion) 34a of one relay terminal 34 and tied up and soldered at the other end portion of the coil to one end portion (tying up portion) 35a of the other relay terminal 35. In the relay terminals 34 and 35, the tying up portion 34a is bent and raised and the other end portion thereof (linkage portion) 35b is also bent and raised. Of relay terminals 34 and 35 fitted to spools 32 and 32 disposed side by side, a linkage portion 35b of adjacent one relay terminal 35 and the tying up portion 34a of the other relay terminal 34 are joined and soldered. Furthermore, the tying up portion 35a of adjacent one relay terminal 35 and a linkage portion 34b of the other relay terminal 34 are joined and soldered, and thereby two coils 31 and 31 are connected. Furthermore, coil terminals 36 and 36 each are extended to a pair of sword guard portions 32a and 32b of the spool 32 (FIG. 4) and connected to the linkage portions 34b and 35b of the relay terminals 34 and 35, respectively.

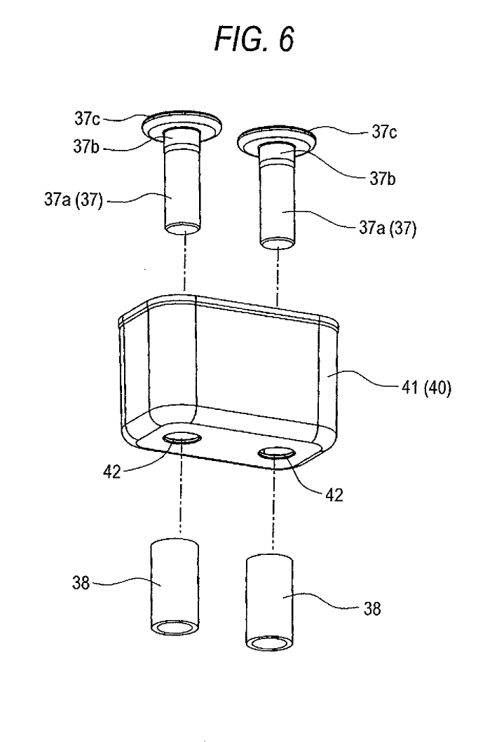

The seal case block 40 includes a sealing case 41 capable of housing a contact mechanism block 50 described later and a seal cover 45 for sealing an opening of the sealing case 41. On a bottom surface of the sealing case 41, a pair of press-fitting holes 42 for press-fitting iron cores 37 is disposed (FIG. 6). On the other hand, in the sealing cover 45, on a bottom surface of a recess 45a formed according to a press process, a pair of insertion holes 46 and 46 capable of inserting connection terminals 75 and 85 of a contact mechanism block 50 described later and loosely engaging holes 47 capable of loosely engaging with the gas venting pipes 21 are disposed (FIG. 4).

The electromagnet block 30 and the sealing case 40 are assembled according to a procedure below.

Firstly, to one sword guard portions 32a of the spool 32, the relay terminals 34 and 35 each are press-fitted, the coil 31 is wound around the spools 32, and lead lines each are tied up to tying-up portions 34a and 35a of the relay terminals 34 and 35 and soldered. In the next place, a pair of spools 32 in which the tying-up portions 34a and 35a and the linkage portions 34b and 35b of the relay terminals 34 and 35 are bent and raised is disposed side by side. Subsequently, tying-up portion 35a of the other relay terminal 35 and the linkage portion 34b of the other relay terminal 34 that are adjacent are joined and soldered, furthermore, linkage portion 35b of the relay terminal 35 and the tying-up portion 34a of the other relay terminal 34 that are adjacent are joined and soldered, and thereby the coils 31 and 31 are connected.

On the other hand, as shown in FIG. 6, an iron core 37 is inserted in each of the press-fitting holes 42 disposed on a bottom surface of the sealing case 41 and to a shaft portion 37a of a protruding iron core 37 a pipe 38 is engaged. Subsequently, when in a shaft center direction of the iron core 37 a pressure is applied from a rim portion of the opening of the pipe 38, an under-neck portion 37b of the iron core 37 is press-fitted with the press-fitting hole 42 of the sealing case 41 expanding and with an inner diameter of the pipe 38 expanding. Furthermore, the rim portions of the openings of the pipes 38 and head portions (magnetic pole portion) 37c of the iron core 37 are pressure bonded vertically to the rim portion of the opening of the press-fitting hole 42 of the seal case 41. Accordingly, the rim portions of the openings of the press-fitting holes 42 of the sealing case 41 are caulked and fixed from three directions.

According to the embodiment, since the sealing case 41 is formed of a material such as aluminum that is equal to or more than the iron core 37 and the pipe 38 in the thermal expansion coefficient, it is advantageous in that even when a temperature varies, the airtightness is not deteriorated.

The reason for this is in that even when a temperature goes up and the respective parts expand, since an expansion in a thickness direction of the sealing case 41 is relatively larger than that of other parts, the sealing case 41 is strongly sandwiched between a head portion 37c of the iron core 37 and the pipe 38. On the other hand, even when a temperature goes down and the respective parts contract, a contraction in a diameter direction of the press-fitting holes 42 of the sealing case 41 is relatively larger than that of other parts, the under-neck portion 37b of the iron core 37 is tightened.

In order to secure the airtightness and to inhibit the thermal stress from occurring, the thermal expansion coefficient of the iron core 37 and that of the pipe 38 are preferably substantially equal.

Furthermore, as the material for the metallic housing, without restricting to pure aluminum, for instance, pure copper, austenite system stainless steel, and low carbon steel can be cited. Still furthermore, in order to improve the sealability of the sealing material and to inhibit the sealing material from deteriorating, the metallic housing may be plated with, for instance, nickel.

Then, the iron core 37 and the pipe 38 are inserted into each of the center hole 32c of the spool 32, a tip end portion of the projected iron core 37 is inserted into a caulking hole 39a of the yoke 39 followed by caulking to fix, and thereby an electromagnet block 30 thereon the sealing case 41 is mounted comes to completion. Between the yoke 39 and the sword guard portion of the spool 32, an insulating sheet 39b is interposed to improve the insulating properties (FIG. 5).

In the next place, between pairs of sword guard portions 32a and 32b of the spool 32, the coil terminals 36 are extended, respectively, and lower end portions of the coil terminals 36, respectively, are linked to the linkage portions 34b and 35b of the relay terminals 34 and 35.

As shown in FIG. 4, the contact mechanism block 50 includes a traveling contact block 60, fixed contact blocks 70 and 80 fitted to both sides thereof, and an insulating case 90 that is engaged therewith to form a unit.

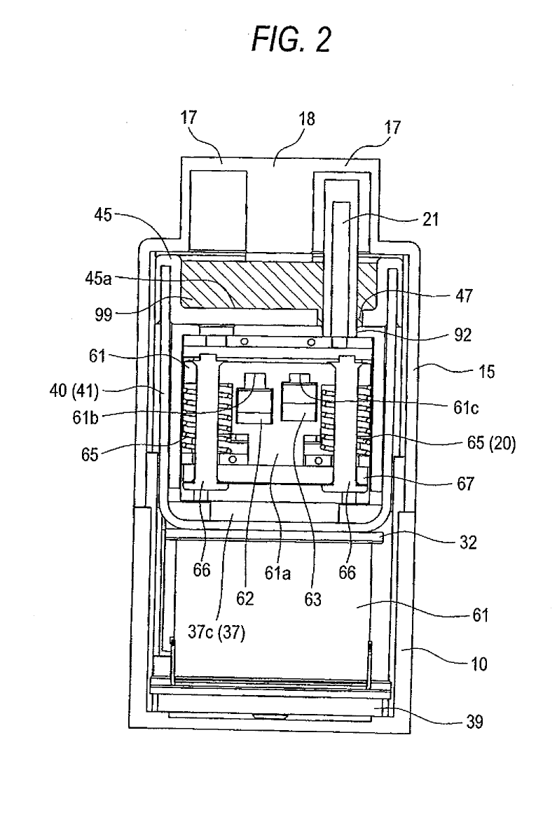

In the traveling contact block 60, on a traveling insulating table 61, a pair of traveling contact segments 62 and 63 (FIGS. 1 and 2) that are disposed side by side is fitted together with contact springs 64 and 64. The traveling insulating table 61 protrudes a leg portion having a substantially cross-shaped cross section on a lower surface of a center portion thereof and caulks and fixes a traveling iron segment 67 through a rivet 66 on each of both sides of which a coil-like return spring 65 is inserted. A lower surface of the traveling iron segment 67 is covered with a magnetism shielding plate.

Of the traveling contact segments 62 and 63, one traveling contact segment 62 is made of a molybdenum band-like conducting material that can withstand a rush current and has a high melting temperature, and the other traveling contact segment 63 is made of a thick band-like copper plate a surface of which is plated with silver.

The contact springs 64 are disposed to impart a contact pressure to the traveling contact segments 62 and 63. The contact springs 64 are formed by bending a band-like spring material into a substantially mountainous shape and folding both end rim portions thereof into engaging pawls.

When the traveling contact segments 62 and 63 and the contact springs 64 and 64, respectively, are inserted in and fitted to a pair of fitting holes 61b and 61c (FIG. 2) disposed side by side in the traveling insulating table 61, both end portions of the traveling contact segments 62 and 63 are engaged with the engaging claws of the contact springs 64. Thereby, the traveling contact segments 62 and 63 can be inhibited from wobbling up and down. Furthermore, when the traveling contact segment 62 is positioned at a position lower than the traveling contact segment 63, a step is formed between a pair of traveling contact segments 62 and 63. Accordingly, the traveling contact segment 62 comes into contact with a fixed contact point before the traveling contact segment 63 comes into contact with the fixed contact point.

As shown in FIG. 4, the fixed contact blocks 70 and 80 are formed by fitting fixed contact point terminals 76 and 86 that have caulked and fixed connection terminals 75 and 85 and a substantially C-shaped cross section and permanent magnets 77 and 87 (FIG. 1), respectively, to fixed contact point tables 71 and 81 that have the same shape and are resin molded products. The fixed contact point tables 71 and 81 project butting projections 72 and 82, respectively, inward on either side and supporting legs 73 and 83, respectively, vertically downward.

As shown in FIG. 4, the insulating case 90 is used to integrate the contact mechanism block 50 into a unit. When a pair of fixed contact point blocks 70 and 80 is fitted from both sides to the traveling contact point block 60 followed by engaging these, from annular ribs 91a formed at rim portions of the terminal holes 91 and 91 of the insulating case 90, the connection terminals 75 and 85 protrude. Furthermore, the insulating case 90 is provided with a pair of gas venting holes 92 in the neighborhood of the terminal holes 91. The reason for disposing a pair of gas venting holes 92 is to eliminate the directionality during assemblage.

In the next place, a procedure of assembling the contact mechanism block 50 will be explained.

Firstly, the traveling iron segment 67 and the magnetism shielding plate (not shown in the drawing) are fitted through the rivet 66 through which the return spring 65 is inserted to the traveling insulating table 61. Subsequently, the traveling contact segments 62 and 63 and the contact springs 64 and 64 are fitted to the traveling insulating table 61. In the next place, with a lower end side of the return spring 65 raising up, the fixed contact blocks 70 and 80 are fitted from both sides of the traveling insulating table 61 followed by butting the butting projections 72 and 82 each other. Furthermore, when the fixed contact blocks 70 and 80 and the insulating case 90 are engaged, the contact mechanism block 50 is completed.

Subsequently, when the contact mechanism block 50 is inserted into the sealing case 41 on which the electromagnet block 30 is mounted, leg portions 73 and 83 of the fixed contact tables 70 and 80 come into contact with a magnetic pole of the iron core 37, and thereby the traveling iron core 67 detachably faces the magnetic pole of the iron core 37. Next, the sealing cover 45 and the sealing case 41 are engaged and soldered together to integrate. At this time, as shown in FIG. 1, inside of the terminal holes 46 and 46 of the sealing cover 45, the terminals 75 and 85 are inserted, respectively, and the annular ribs 91a of the insulating cover 90 are engaged, respectively. Furthermore, from the loosely fitting holes 47, the gas venting pipes 21 are press-fitted into the gas venting holes 92 of the insulating case 90. Subsequently, a sealing material 99 is poured in the recess 45a of the sealing cover 45 followed by solidifying, and thereby the surroundings of base portions of the connection terminals 75 and 85 and the gas venting pipes 21 are sealed. In the next place, air in the sealing case 40 is evacuated from the gas venting pipes 21, a predetermined gas mixture is injected, after that, the gas venting pipes 21 are caulked and sealed. Furthermore, the coil terminal 36 is extended between a pair of sword guard portions of the spool 32 and fixed thereto, and thereby a relay body 20 comes to completion.

Subsequently, the relay body 20 is housed in the recess 11 of the case 10 and the coil terminals 36 are disposed to the connecting recesses 13. Furthermore, the cover 15 is fitted to the case 10, and thereby a DC switching relay comes to completion.

As the sealing material 99, a liquid thermosetting polymer filled with inorganic filler is used. As the liquid thermosetting polymer, for instance, an epoxy resin, a phenol resin, a silicone resin and so on can be cited.

In particular, liquid aromatic and hydrogenated aromatic epoxy resins means epoxy resins that have an aromatic ring or a hydrogenated aromatic ring such as a benzene ring, a naphthalene ring, and a hydrogenated benzene ring and two or more terminal epoxy groups, and are liquid in the neighborhood of room temperature.

To the aromatic and hydrogenated aromatic rings, a substituent group such as an alkyl group and a halogen atom may bond. The terminal epoxy group and the aromatic or hydrogenated aromatic ring are bonded through oxyalkylene, poly(oxyalkylene), carboxyalkylene, carbopoly(oxyalkylene), aminoalkylene and so on. The terminal epoxy group is bonded directly or through oxyalkylene, poly(oxyalkylene), or carboxyalkylene and so on to the aromatic or hydrogenated aromatic ring. Specifically, bisphenol A diglycidyl ether, bisphenol F diglycidyl ether, diglycidyl ether of two mole addition product of bisphenol A and ethylene oxide, diglycidyl ether of two mole addition product of bisphenol A and 1,3-propylene oxide, hydrogenated bisphenol A diglycidyl ether, hydrogenated bisphenol F diglycidyl ether, orthophthalic acid diglycidyl ester, tetrahydroisoorthophthalic acid diglycidyl ester, N,N-diglycidyl aniline, N,N-diglycidyl toluidine, N, N-diglycidylaniline-3-glycidyl ether, tetraglycidyl methaxylene diamine, 1,3-bis(N,N-diglycidylaminomethylene)cyclohexane can be cited. In the present invention, one or more kinds can be selected from the epoxy resin group to use. Depending on the cases, other than the above, one or more kinds of mono-functional or poly-functional epoxy resins that are solid in the neighborhood of room temperature may be added. As the solid mono-functional or poly-functional epoxy resin, ones having a structural formula shown by a chemical formula 1, phenol-novolac epoxy resins, cresol-novolac epoxy resins, dicyclopentadiene epoxy resins, naphthalene epoxy resins, naphthol-modified novolac epoxy resins, bisphenol fluorene diglycidyl ether, biscresol fluorene diglycidyl ether, and bisphenoxy ethanol fluorene diglycidyl ether can be cited.

### [Ka 1]

The inorganic filler is added to the liquid thermosetting polymer so as to make the thermal expansion coefficient of the sealing material 99 equal to or more than that of the sealing case block 40. For instance, aluminum oxide, fused silica, boron nitride, aluminum nitride, silicon carbide, silicon nitride, zirconium oxide and mullite can be cited.

Furthermore, an average particle diameter of the inorganic filler is preferably in the range of 1 to 30 μm, and, in particular, more preferably in the range of 10 to 12 μm. In the case of the average particle diameter being less than 1 μm, blending becomes impossible; on the other hand, in the case of it exceeding 30 μm, the viscosity becomes higher, resulting in incapability of obtaining desired fluidity.

Furthermore, an addition amount of the inorganic filler is in the range of 70 to 85% by weight of the liquid thermosetting resin, and, in particular, preferably in the range of 75 to 85% by weight. When it is less than 70% by weight, the liquid thermosetting resin intrudes inside from a gap of parts during curing and adversely affects on inner constituent parts; on the other hand, when the addition amount exceeds 85% by weight, the viscosity becomes too high and the inorganic filler cannot be injected or filled into minute portions of a target at normal temperature.

Furthermore, as needs arise, a curing agent and/or a curing accelerator may be added to the liquid thermosetting polymer. As the curing agent, for instance, dicarboxylate anhydride, tricarboxylate anhydride, tetracarboxylate anhydride, dicarboxylate dihydrazide, and dicyandiamide can be cited. An addition amount of the curing agent is preferably in the range of 3 to 15% by weight. When it is less than 3%, an appropriate curing accelerating function cannot be obtained; on the other hand, when it exceeds 15%, the characteristics as an adhesive cannot be obtained.

Still furthermore, as the curing accelerator, for instance, Amicure PN-23, PN-31, PN-40, MY-24 and MY-H (manufactured by Ajinomoto Finetechno Co., Ltd.) and Hardener H3293S and H3615S (A.C.R Co., Ltd.) that are all commercially available as a solid epoxy amine adduct can be cited. An addition amount of the curing accelerator is preferably in the range of 1 to 30% by weight. When it is less than 1%, desired curing accelerating function cannot be obtained; on the other hand, when it exceeds 30%, the characteristics as the adhesive cannot be obtained.

The viscosity of the sealing material is 150×10⁴ mPa·s or less and, in particular, preferably in the range of 50×10⁴ mPa·s to 70×10⁴ mPa·s. When it is less than 50×10⁴ mPa·s, the sealing material intrudes through a gap between parts and adversely affects on internal constituent parts; on the other hand, when it exceeds 150×10⁴ mPa·s, a sealing operation where the sealing material is injected at room temperature with an air coating machine becomes very difficult.

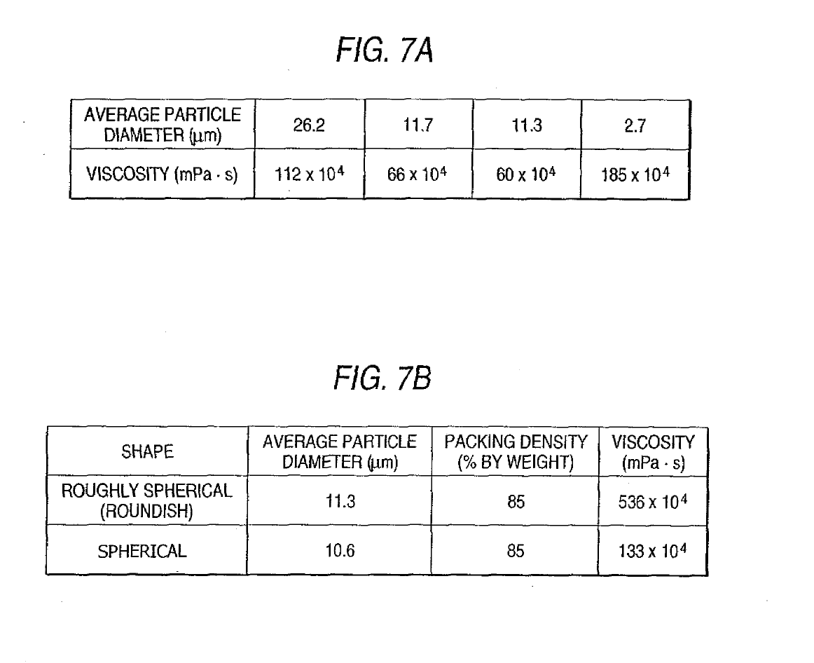

For instance, to an epoxy resin, each of substantially spherical aluminum oxide (alumina) powders having different average particles diameters was added by 75% by weight, and the viscosity was measured. Measurements are shown in FIG. 7A. All alumina powders used here are ones manufactured by showa Denko K.K. For one having an average particle diameter of 26.2 μm, product No. AS-10 was used; for one having 11.7 μm, product No. AS-50; for one having 11.3 μm, product No. AS-50; and for one having 2.7 μm product No. CB-A05S. Furthermore, the viscosity was measured with a rotation viscometer under a shearing velocity of 0.5 (l/s).

As obvious from the viscosities shown in FIG. 7A, it was found that the inorganic fillers having average particle diameters of 26.2 μm, 11.7 μm and 11.3 μm could be preferably used. Furthermore, it was also found that even when a shape of the inorganic filler is substantially spherical, when an appropriate average diameter is selected, a sealing material having desired viscosity could be obtained.

Furthermore, to an epoxy resin, each of alumina powders different in the average particle diameter and the shape is added by 85% by weight, and the viscosity was measured. Measurements are shown in FIG. 7B.

For alumina powder having an average particle diameter of 11.3 μm, As-50 manufactured by Showa Denko K.K. was used and for alumina powder having an average particle diameter of 10.6 μm, AO-509 manufactured by Admatechs Co., Ltd. was used.

As obvious from the viscosities shown in FIG. 7B, it was found that even when an addition amount of the inorganic filler was 85% by weight, when the shape of the inorganic filler was spherical, the sealing material having desired viscosity could be obtained. Furthermore, it was also found that even when addition amounts of the inorganic fillers were the same, when the shapes of the inorganic fillers were different, the viscosity varied largely, in particular, when the shape was spherical, the viscosity remarkably decreased.

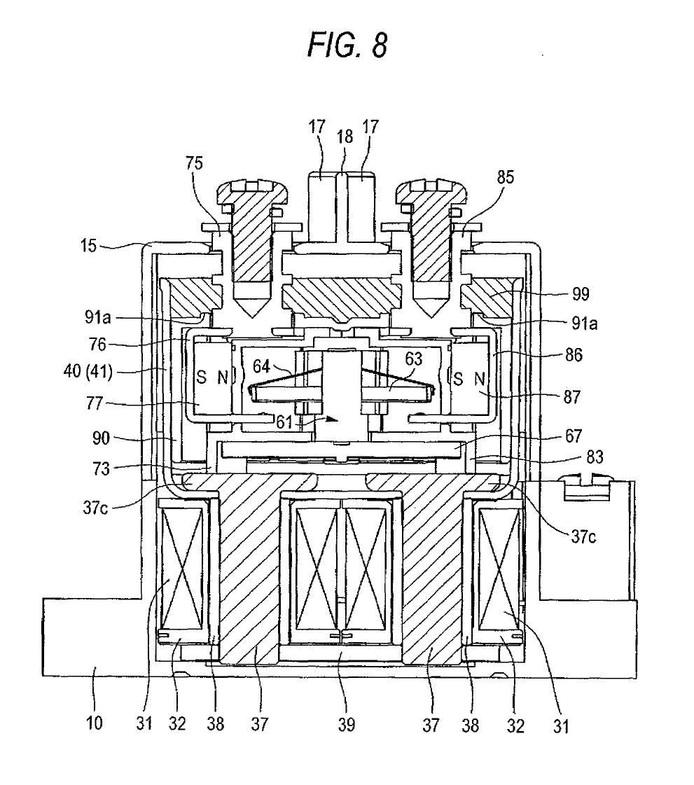

A second embodiment relates to a case where, as shown in FIGS. 8 through 10, similarly to the first embodiment, the present invention is applied to a DC load switching relay. The DC load switching relay according to the present embodiment is substantially similar to that according to the first embodiment with the exception that the present DC load switching relay does not have a sealing cover 45 according to the first embodiment. Accordingly, the same portions will be imparted with the same reference numerals and explanations thereof will be omitted.

### EXAMPLES

### Example 1

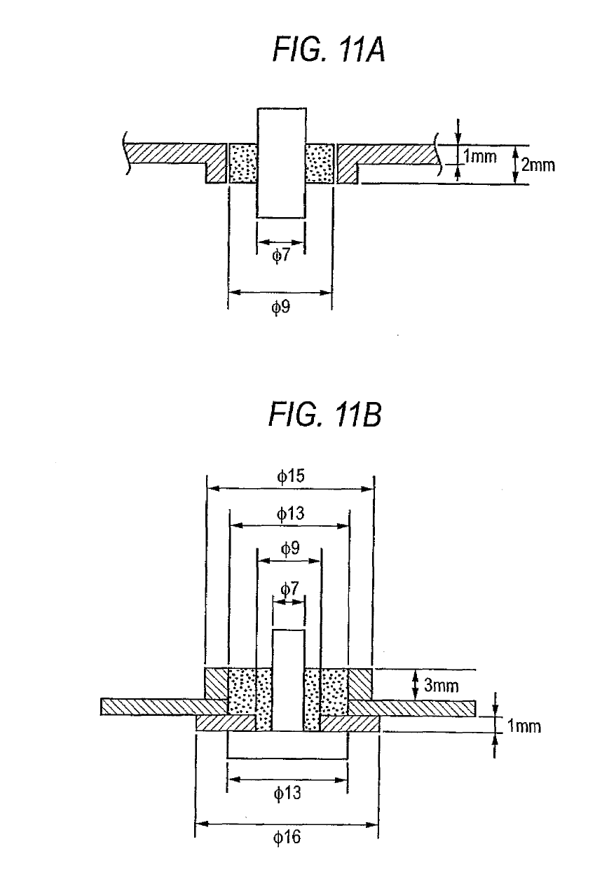

In a pure aluminum (A1050) disc having a diameter of 48.1 mm and a thickness of 1 mm, a hole was bored with a drill followed by applying drawing, and thereby a terminal hole having a diameter of 9 mm and a depth of 2 mm was formed. A terminal that is made of oxygen-free copper (C1020) and has a diameter of 7 mm was inserted into the terminal hole, the sealing material was poured into a gap between both and cured at 120 degree centigrade for 1.5 hr, and thereby a test model 1 (FIG. 11A) was obtained.

As the sealing material, one pack type liquid epoxy resins were prepared by blending an epoxy resin, a curing agent and a curing accelerator at a weight ratio of 100:4:3, followed by adding alumina powder so as to be 25%, 50%, 75% and 90% in terms of total weight ratio, further followed by blending by means of a stirrer. However, in the case of the alumina powder being added so as to be 90% in terms of the total weight ratio, though it could be mixed, the viscosity was too large to fill in the test model 1. Accordingly, evaluation of the airtightness thereof was not carried out.

As the epoxy resin, bis-phenol A diglycidyl ether (epoxy equivalent 190) that is a liquid aromatic polyfunctional epoxy resin was used. As the curing agent, dicyandiamide that is a solid epoxy resin curing agent and has an average particle diameter of 10 μm was used. Furthermore, as the curing accelerator, solid epoxy amine adduct having an average particle diameter of 10 μm (PN-23 manufactured by Ajinomoto Finetechno Co., Ltd.) was used. Still furthermore, as the alumina powder, ones having an average particle diameter of 10 μm were used. In particular, in the case of the addition amount of alumina powder being 25%, 50% and 75% by weight, AS-50 (manufactured by Showa Denko K.K) having a substantially spherical shape was used, and in the case of 90%, AO-509 having a spherical shape (manufactured by Admatechs Co., Ltd.) was used.

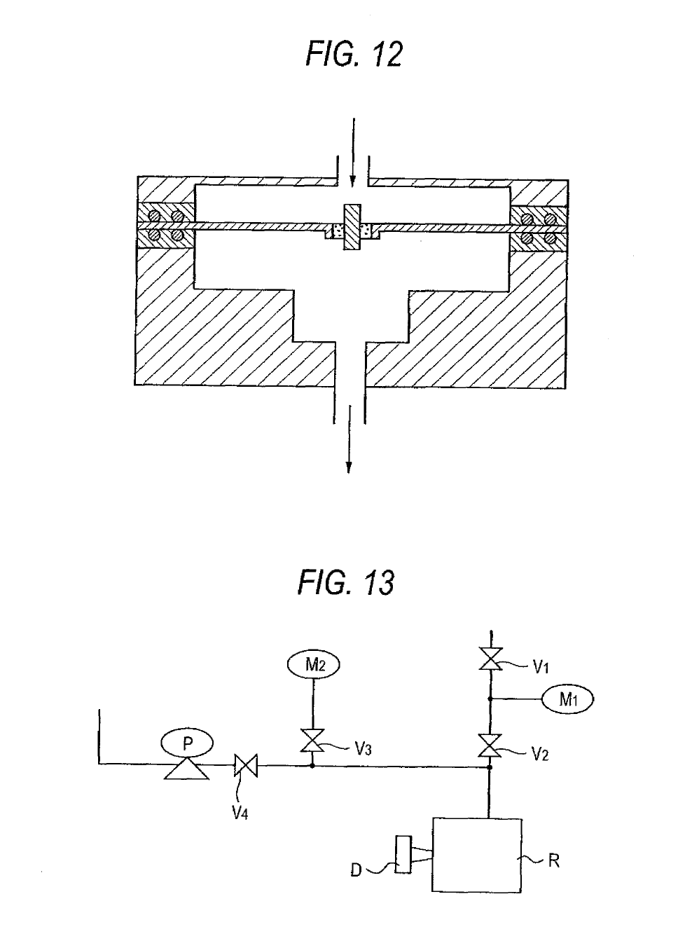

Subsequently, after heat shock was applied on the test model 1, the test model 1 was fitted to a leak detector (UL-200 manufactured by Leybold Inficon Inc.,) that is a test device shown in FIG. 12 and the air-tightness evaluation was carried out. The heat shock was applied by repeating a cycle of holding the test model 1 at −40 degree centigrade for 5 min, followed by heating to 125 degree centigrade in 3 min and maintaining there for 5 min, further followed by cooling to −40 degree centigrade in 3 min.

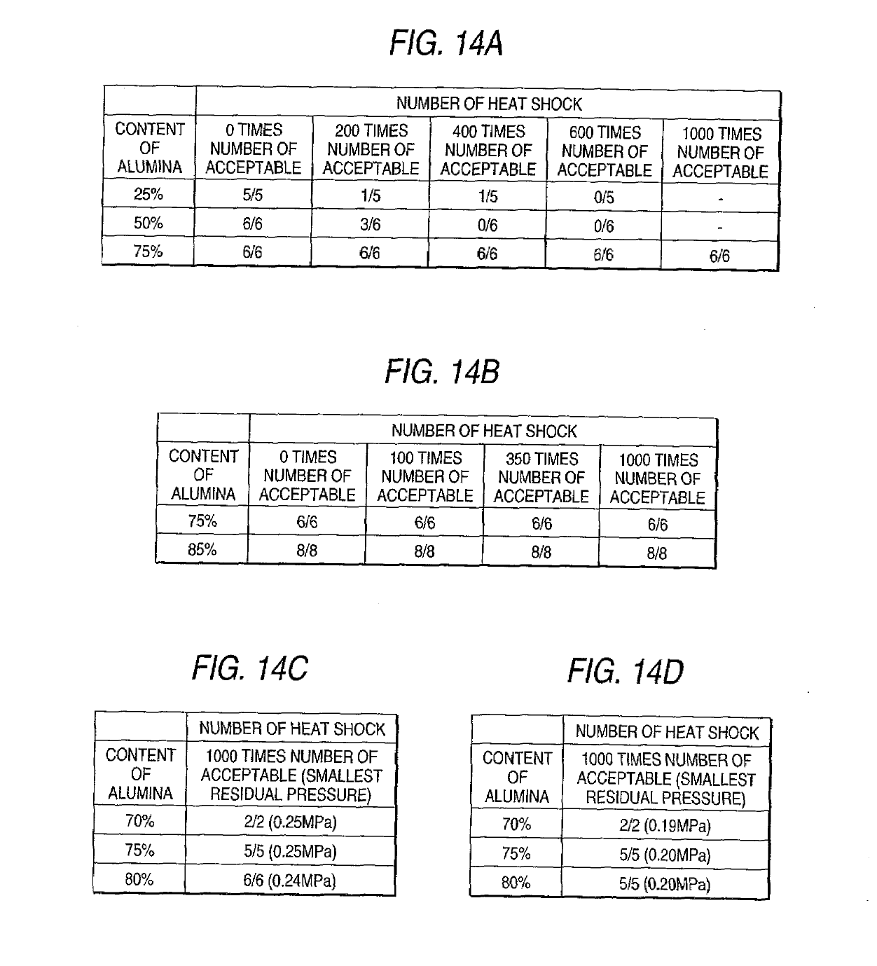

The air-tightness was evaluated by measuring the helium leak rate at normal temperature when, as shown in FIG. 12, one side of the test model 1 was evacuated at a vacuum of an internal pressure of 0.1 Pa or less and the other side thereof was pressurized by injecting helium gas at a pressure of 0.1 MPa. An acceptable criterion was set at 1×10⁻⁹ Pa·m³/s or less. The acceptable criterion means an amount of leakage (leak rate) where a half an internal gas pressure at an initial charging time can remain at normal temperature after 10 years. Measurements are shown in FIG. 14A.

### Example 2

A terminal hole having a diameter of 13 mm was drilled in an aluminum disc having a thickness of 1 mm and, to an upper surface rim portion in the surroundings of the terminal hole, a cylindrical body having an external diameter of 15 mm, an internal diameter of 13 mm and a height of 3 mm was soldered and integrated into one body. Furthermore, in a central hole of a resinous sealing disc that has an external diameter of 16 mm, an internal diameter of 9 mm and a thickness of 1 mm and is located at a bottom surface rim portion in the surroundings of the terminal hole, a terminal that has a diameter of 7 mm and at a lower end portion of which a flange having a diameter of 13 mm is integrated was inserted. Sealing materials that were obtained by processing similarly to Example 1 except for an additional amount of alumina powder being set at 75 and 85% by weight were injected followed by heating and curing, and thereby test models 2 (FIG. 11B) were obtained. An average particle diameter of the alumina powder was 10 μm, and, in the case of an addition amount thereof being 75%, AS-50 (manufactured by Showa Denko K. K.) whose shape is substantially spherical was used and in the case of 85%, AO-509 (manufactured by Admatechs Co., Ltd.) whose shape is spherical was used.

Under the same conditions as in the Example 1, heat shock was repeatedly applied to evaluate the air-tightness. Measurements are shown in FIG. 14B.

### Example 3

This is a case where the present invention is applied to a DC load switching relay involving a first embodiment shown in FIGS. 1 through 6. In particular, as shown in FIG. 4, on a bottom surface of a sealing case cover that is obtained by press-working a plane table like pure aluminum material (A1050) having a thickness of 1 mm and has a width of 21 mm, a length of 36 mm and a depth of recess of 4 mm, a terminal hole having a diameter of 12 mm and a gas venting hole having a diameter of 5 mm were disposed. While a copper alloy (alloy 194) having a maximum external diameter of 7 mm and a minimum external diameter of 5 mm was inserted through a flange portion of a resinous insulating cover into the terminal hole and located, a pure copper gas venting pipe having an external diameter 3 mm was press-fitted in a resinous insulating cover and located. Sealing materials obtained by processing similarly to example 1 except for setting an additional amount of alumina powder at 70%, 75% and 80% by weight were injected into the recess of the sealing cover, heated at 125 degree centigrade for 2 hr to cure, and thereby test models 3 were obtained. In the next place, heat shock was repeatedly applied followed by evaluating the air-tightness with an evaluation system shown in FIG. 13. Measurements are shown in FIG. 14C.

For the alumina powder added in the example, AS-50 manufactured by Showa Denko K.K. and having a substantially spherical shape and an average particle diameter of 10 μm was used.

The heat shock to the test model 3 was applied by repeating a cycle of holding the test model 3 at −40 degree centigrade for 30 min, followed by heating to 125 degree centigrade in 5 min and maintaining there for 30 min, further followed by cooling to −40 degree centigrade in 5 min. The heat shock was applied assuming to be equivalent to one given during 10 years of heat stress under practical conditions.

Furthermore, the airtightness of Example 3 was evaluated by filling hydrogen at an absolute pressure of 0.3 MPa before the heat shock was applied and by measuring a residual internal pressure after the heat shock by use of a self-produced internal pressure measurement device shown in FIG. 13. One of which the residual pressure was 0.15 MPa or more was judged as acceptable one. The acceptable criterion corresponds to a case where as an indicator of an extent of leakage of the interior gas after application of the heat stress equivalent to 10 years' heat stress, a gas pressure after the test becomes a half or more a gas pressure at the time of initial filling.

In a method of measuring an internal pressure, as shown in FIG. 13, by taking advantage of the pressure difference of a vacuum gauge M1 and a vacuum gauge M2, a residual internal gas pressure of the test model 3 housed in an internal gas release chamber R is measured.

That is, firstly, with valves V1 and V2 opened and with valves V3 and V4 closed, a vacuum pump P is turned over. On the other hand, the test model 3 is housed in the internal gas release chamber R. Subsequently, the valve V2 is closed to confirm for the vacuum gauge M1 to indicate atmospheric pressure. In the next place, after the valve 4 is opened followed by opening the valve V3, the internal gas release chamber R is evacuated and a pressure (m1) of the vacuum gauge M2 is recorded. Furthermore, the valves V1 and V4 are closed and the valve V2 is opened to introduce air into the internal gas release chamber R, and a pressure (m2) of the vacuum gauge M2 is recorded. The valve V2 is closed and the valve V4 is opened to evacuate. Subsequently, after the valve V4 is closed, by use of a boring drill D belonging to the internal gas release chamber R a hole is opened in a sealing case block of the test model 3, thereby hydrogen gas remaining in the test model 3 is released in the internal gas release chamber R, and a pressure (m3) of the vacuum gauge M2 is recorded. In the next place, the valve V4 is opened to evacuate the released hydrogen gas. Then, after evacuation, the valve V4 is closed and the valve V1 is opened, after it is confirmed that the vacuum gauge M1 indicates atmospheric pressure, the valve V1 is closed. Subsequently, after the valve V2 is opened to introduce air, a pressure (m4) of the vacuum gauge M2 is recorded. Finally, after the valve V2 is closed and the valve V4 is opened to evacuate, the valves V4 and V3 are closed and the valves V1 and V2 are opened, thereby the internal gas release chamber R is opened to atmosphere and the test model 3 is taken out.

In the next place, with a volume of air in a pipe between the valve V1 and the valve V2 is taken as C, and with atmospheric pressure as A, a volume B1 in the internal gas release chamber R before breaking can be obtained from

B1═C(A−m2)/(m2−m1).

On the other hand, a volume B2 in the internal gas release chamber R after breaking can be obtained from

B2=C{(A−m4)/(m4−m1)−(A−m2)/(m2−m1)}.

Accordingly, an internal gas pressure P1 remaining in the test model 3 can be obtained from

P1=B2(m3−m1)/(B2−B1).

Calculation results are shown in FIG. 14C.

### Example 4

The present example relates to a case where the present invention is applied to a DC load switching relay according to the example 2 shown in FIGS. 8 through 10. A test model 4 was obtained by assembling according to the procedure the same as that of the example 3 and thereto under the conditions the same as that of the example 3 an experiment was carried out. Measurements and calculation results are shown in FIG. 14D.

It was found that as obvious from measurements shown in FIGS. 14A and 14B, when alumina powder is added by 75% by weight or more, and as obvious from FIGS. 14C and 14D, when alumina powder is added by 70% by weight or more, a seal structure strong against the heat shock could be obtained. This is considered that since, by adding alumina powder to the sealing material, the thermal expansion coefficient of the sealing material is made similar to that of the housing and the terminal, these similarly expand or contract.

Furthermore, when Examples 1 and 2 and Examples 3 and 4 are compared and studied, it was confirmed that in the case of a metallic terminal being inserted into a terminal hole disposed to a metallic housing to seal, alternatively, not only in the case of a metallic housing and a metal terminal being directly sealed but also in the case of a synthetic resin being interposed therebetween, the similar sealability could be secured.

It goes without saying that the sealing structure and the sealing material of the terminal according to the present invention, without restricting to an electromagnetic relay, can be applied also to other switching devices such as a switch.

1.-7. (canceled)

8. A method for sealing a terminal, comprising:
inserting a terminal into a terminal hole through a resinous housing exposed within an opening of a metallic housing;
injecting a sealing material in fluid form into the opening of the metallic housing; and allowing the sealing material in fluid form to be solidified,
wherein, by adding an inorganic filler to a liquid thermosetting polymer, the thermal expansion coefficient of the sealing material is made equivalent to or greater than that of the metallic housing, and
wherein a viscosity of the sealing material is between 500,000 and 1,500,000 centipoise.

9. The method of claim 8, wherein the liquid thermosetting polymer is a latent epoxy resin.

10. The method of claim 8, wherein the inorganic filler comprises aluminum oxide powder having an average particle diameter in the range of 1 to 30 μm.

11. The method of claim 8, wherein an addition amount of inorganic filler is in the range of 70 to 85% by weight.

12. The method of claim 8, further comprising heating the sealing material after the injection so as to be solidified.
